(19) United States
(12) Patent Application Publication
(10) Pub. No.: US 2002/0023553 A1
(43) Pub. Date: Feb. 28, 2002

(54) Device for binding sheets and bound sheets

(76) Inventor: Francesco Rebora, Genova (IT)

Correspondence Address: J. Rodman Steele, Jr., Akerman, Senterfitt & Eidson, P.A., Post Offic Box 3188, West Palm Beach, FL, 33402-3188, US

(21) Appl. No.: 09/862,796

(22) Filed: May 22, 2001

Related U.S. Application Data
(63) Continuation of application No. PCT/IT99/00385, filed on Nov. 24, 1999.

(30) Foreign Application Priority Data
Nov. 24, 1998 (IT) TO98A000988

(51) Int. Cl. B41F 1/00

(52) U.S. Cl. 101/2

(57) ABSTRACT

A device for binding sheets in a pack, the device having a flat rectangular sheet element (3) in turn having, along one major side (3a), a number of flexible tongues (7) arranged combfashion; and a closing strip (10) extending along the major side (3a). The strip (10) has an application surface (13) facing the tongues (7) and having a layer of adhesive (17). The flat element (3) is placeable on a first face of the pack, with the tongues (7) inserted inside the respective holes (33) formed along one edge of the pack, and with respective ends (7e) of the tongues (7) projecting from the holes. The closing strip (10) is foldable and placeable with the layer of adhesive (17) superimposed on a flat element (30b) defining a second face of the pack (30).

### TECHNICAL FIELD

The present invention relates to a device for binding sheets in a pack, and to a bound bundle.

### BACKGROUND ART

As is known, packed sheets with holes along one edge of the pack are bound using substantially tubular binding devices comprising an elongated, substantially C-section spine portion, and a number of curved tongues formed integrally with the spine portion and spaced to form an elastic comblike structure. Each tongue is inserted inside a respective (preferably rectangular) hole in the pack and through the pack so that a respective end portion rests on an inner surface of the spine portion to firmly connect and bind the sheets into a bundle.

Known binding devices of the above type have a number of drawbacks, including the following:

the elongated spine portion projects frontwards and laterally from the bundle, so that the bundle is often difficult to shelve or place alongside other bound bundles;

binding devices of different sizes, in particular with elongated spine portions of different shape and width, are required for binding bundles of different thickness;

writing or printing is not normally possible on the spine of the bound bundle, by the spine being defined by the outer surface of the spine portion, which is curved and made of plastic material;

the binding device (being made of plastic material) must be detached from the packed sheets when disposing of, e.g. burning, the bundle.

### DISCLOSURE OF INVENTION

It is an object of the present invention to provide a device for binding packed sheets, designed to eliminate the drawbacks of known devices.

According to the present invention, there is provided a binding device of the type described in claim 1.

The present invention also relates to a bound bundle of the type described in claim 16.

### BRIEF DESCRIPTION OF THE DRAWINGS

A non-limiting embodiment of the invention will be described by way of example with reference to the accompanying drawings, in which:

FIG. 1 shows a view in perspective of a binding device in accordance with the teaching of the present invention;

FIG. 2 shows a larger-scale view in perspective of a portion of the FIG. 1 binding device;

FIG. 3 shows a variation of the FIG. 2 binding device;

FIG. 4 shows a section along line IV-IV in FIG. 2;

FIG. 5 shows a view in perspective of a first stage in the use of the binding device;

FIG. 6 shows a view in perspective of a second stage in the use of the binding device;

FIG. 7 shows a view in perspective of a third stage in the use of the binding device;

FIG. 8 shows a view in perspective of a bound bundle formed using the FIG. 1 binding device.

### BEST MODE FOR CARRYING OUT THE INVENTION

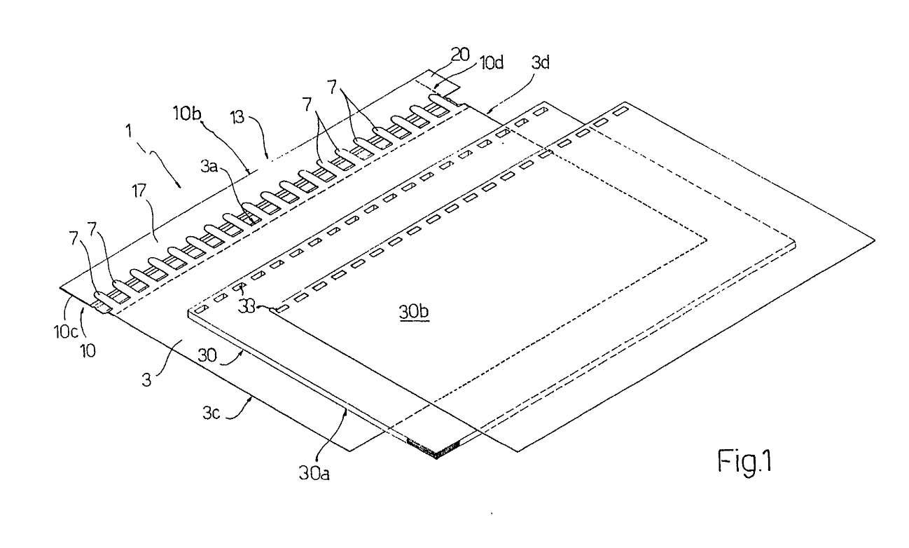

Number 1 in FIG. 1 indicates as a whole a binding device comprising a rectangular flat sheet element 3 having a number of flexible tongues 7 arranged combfashion along a straight major side 3a. Tongues 7 are preferably die-cut integrally with flat sheet element 3.

Flat sheet element 3 may be formed by die-cutting a sheet of cardboard, a sheet of plastic material (e.g. transparent plastic material), or a sheet of metal (e.g. a flexible sheet of aluminium). That is, flat sheet element 3 may be made of various materials, providing sufficient flexibility of tongues 7 is ensured.

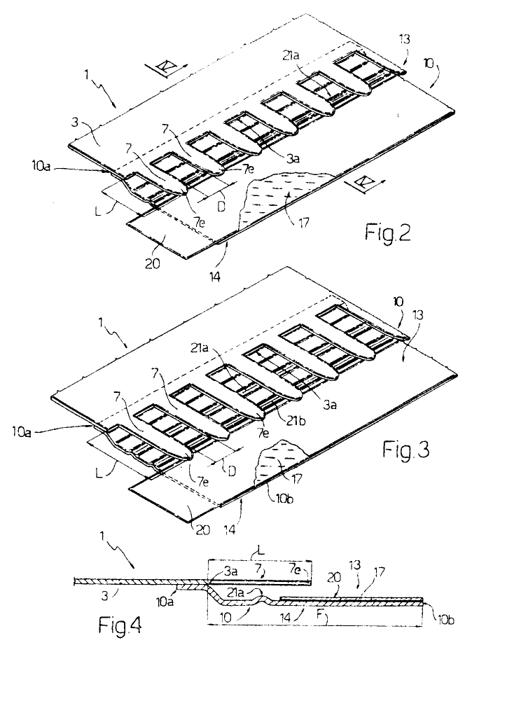

Tongues 7 are equally spaced with spacing D (FIGS. 2 and 3) along straight major side 3a, and are all of the same length L; and each tongue 7 extends perpendicularly to side 3a, and is rectangular with a rounded minor-side free end 7e.

Binding device 1 also comprises a strip-shaped closing element 10 extending along the whole of straight major side 3a of flat element 3, and preferably made of the same material as flat element 3. More specifically, closing strip 10 is rectangular, and comprises a first straight major edge portion 10a (FIG. 4) glued to flat sheet element 3 along straight major side 3a; and two minor edges 10c, 10d (FIG. 1) aligned with the minor sides 3c, 3d of rectangular flat element 3.

Closing strip 10 has an application surface 13 facing tongues 7, and a surface 14 facing away from tongues 7.

Application surface 13 has an adhesive strip 17 extending along a second straight major edge portion 10b of strip 10. Adhesive strip 17 comprises a removable cover strip 20, and is preferably defined by a biadhesive strip along straight major edge lob of closing strip 10.

Adhesive strip 17 may also be normally solid and formable thermally; in which case, cover strip 20 may be dispensed with.

Closing strip 10 (FIG. 4) has a useful width F (measured between second edge portion 10b and side 3a) greater than the length L of each tongue 7, so that the end portion 7e of each tongue faces application surface 13 when strip 10 is undeformed and substantially flat. Closing strip 10 may also be made of cloth.

Closing strip 10 also has a preferential bend line 21a (FIG. 2) extending the whole length of the closing strip and parallel to major edges 10a and 10b of strip 10 and to side 3a of flat sheet element 3. Preferential bend line 21a extends along a portion of surface 13 not covered with adhesive.

A larger number of bend lines may be provided, e.g. two (or more) as shown in FIG. 3, which shows two preferential bend lines 21a, 21b extending parallel to major edges 10a and 10b of strip 10 and therefore parallel to side 3a of flat sheet element 3. Both preferential bend lines 21a, 21b extend along a portion of surface 13 not covered with adhesive.

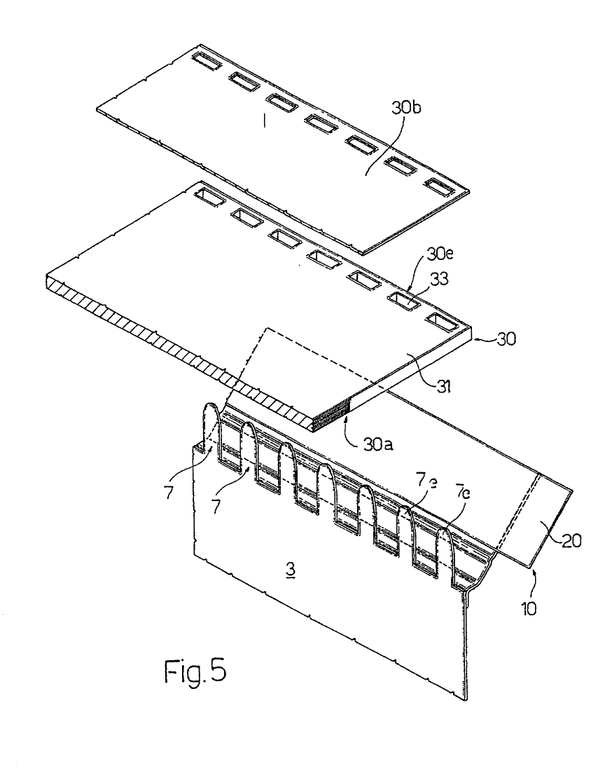

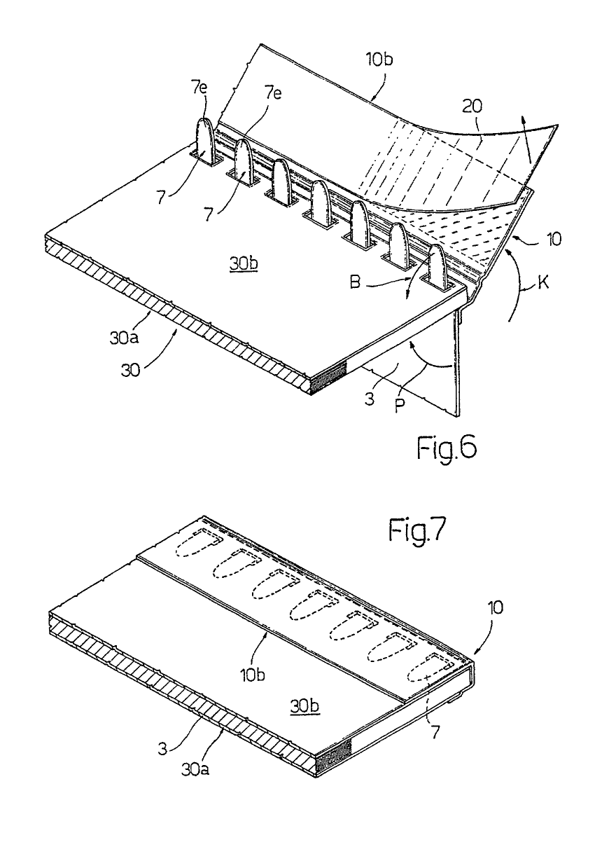

To use the device according to the present invention, a pack 30 (FIGS. 1 and 5) is prepared of rectangular sheets 31 having a series of rectangular-section holes 33 extending along a straight major edge 30e of pack 30. Pack 30 is defined, on opposite faces, by flat end elements 30a, 30b preferably defined by a sheet and by a semirigid element (e.g. cardboard, as shown in FIG. 1). In FIGS. 5 and 1, flat element 30b is shown detached from the other parts of pack 30 for the sake of clarity.

According to the present invention, each tongue 7 is inserted through a respective hole 33 in pack 30 so that each end 7e projects from hole 33 (FIGS. 5 and 6). This may be done manually (FIGS. 5 and 6) by placing flat sheet element 3 vertically with tongues 7 facing upwards, placing pack 30 horizontally and perpendicular to tongues 7, and at the same time moving pack 30 towards tongues 7 so as to insert the tongues inside respective holes 33 (FIG. 6). At this point, flat sheet element 3 is folded (arrow P) onto a first face of pack 30. More specifically, flat element 3 is folded onto flat end element 30a of pack 30, with tongues 7 still inserted inside holes 33 and with pack 30 in the preceding position (for instance still horizontal), so as to bend tongues 7 at their respective bases.

The ends of tongues 7 projecting from pack 30 are then bent (arrow B) onto flat end element 30b (preferably made of semirigid material) defining a second face of pack 30.

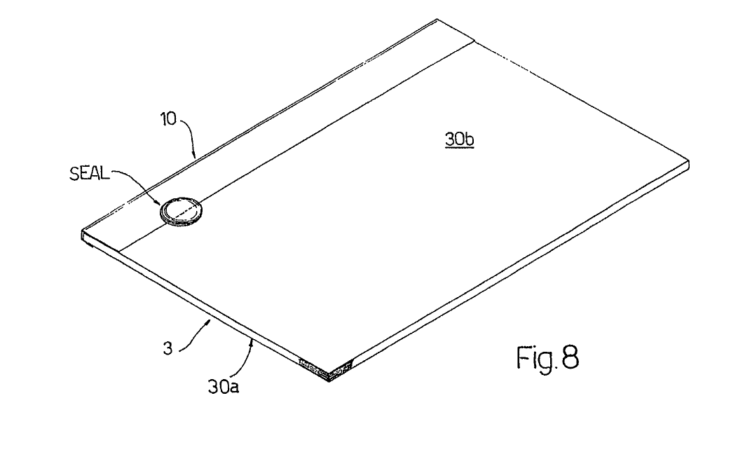

Cover strip 20 is removed (FIG. 6) and closing strip 10 is gripped and folded into a C (arrow K, FIGS. 6 and 7) so that the peripheral portion of closing strip 10 adjacent to edge lob is superimposed on flat end element 30b defining the second face of pack 30, and adhesive strip 17, with cover strip 20 removed, adheres firmly to the portion of flat element 30b close to holes 33, and to the underlying portions of tongues 7. As stated, flat element 30b defining the second face of pack 30 is preferably made of sufficiently rigid material, e.g. cardboard or plastic. Adhesive strip 17 thus provides for firmly connecting strip 10 and flat element 30b, and so ensuring connection of flat element 30b and flat element 3, while the sheets of pack 30 are retained firmly between flat element 30b and flat sheet element 3, which respectively define the rear and front cover of a bound bundle (FIG. 8).

The advantages of the present invention will be clear from the foregoing description:

closing strip 10 does not project with respect to the thickness of the bundle, which, being substantially parallelepipedal with no projecting parts, is therefore easy to shelve or place alongside other bound bundles;

since a portion of each tongue 7 need simply project from the pack of sheets, device 1 may be used for binding packs of sheets of different thicknesses;

writing or printing may be applied to strip 10, the central portion of surface 14 of which defines the spine of the bound bundle;

writing or printing may also be applied to flat sheet element 3 which, depending on the arrangement of the sheets in the bundle, defines the front or rear cover of the bound bundle;

the binding device may be made of recyclable (e.g. paper) material to avoid the necessity of removing the device when disposing of, e.g. burning, the bundle.

Moreover, binding device 1 may be made by simply die-cutting and gluing readily available materials, and is therefore cheap and easy to produce.

The binding device may also be used for security purposes, to prevent sheets from being replaced or added to the bundle, by, for example, initialling or applying a SEAL to the overlapping portion of closing strip 10 and flat end element 30b (FIG. 8). In the event the bundle is opened, closing strip 10 is detached from flat end element 30b, thus destroying or altering the initialling or the SEAL.

Clearly, changes may be made to the binding device as described and illustrated herein without, however, departing from the scope of the present invention.

1) A device for binding sheets in a pack, characterized by comprising:
a flat sheet element (3) having, along one side (3a), a number of flexible tongues (7) arranged combfashion;
a closing element (10) extending along said side (3a) of the flat sheet element (3); said closing element (10) having an application surface (13) facing said tongues (7);
said flat sheet element (3) being placeable on a first face (30a) of said pack, with said tongues (7) inserted inside respective holes (33) formed along an edge (30e) of the pack, and with respective ends (7e) of the tongues (7) projecting from the holes;
said closing element (10) being foldable and placeable with at least one portion (17) of the application surface (13) superimposed on and firmly connected to a flat element (30b) defining a second face of the pack (30) to form a bound bundle.

2) A device as claimed in claim 1, characterized in that said tongues (7) are integral with said flat sheet element (3).

3) A device as claimed in claim 1, characterized in that said tongues (7) are formed integrally with said flat sheet element (3) by die-cutting.

4) A device as claimed in any one of the foregoing claims, characterized in that said tongues (7) extend along a straight side (3a) of said flat sheet element (3).

5) A device as claimed in any one of the foregoing claims, characterized in that said flat sheet element (3) has a rectangular perimeter.

6) A device as claimed in any one of the foregoing claims, characterized in that said closing element (10) has a respective peripheral edge (10a) fixed to said flat sheet element (3) along said side (3a).

7) A device as claimed in any one of the foregoing claims, characterized in that said closing element (10) is rectangular.

8) A device as claimed in any one of the foregoing claims, characterized in that said closing element (10) has at least one preferential bend line (21a, 21b) extending in a direction substantially parallel to said side (3a) of said flat sheet element (3).

9) A device as claimed in any one of the foregoing claims, characterized in that said application surface (13) has at least one portion (17) covered with adhesive.

10) A device as claimed in claim 9, characterized in that said portion (17) covered with adhesive extends along a peripheral portion (10b) of said closing element (10).

11) A device as claimed in claim 9, characterized in that said portion (17) covered with adhesive has a removable cover strip (20).

12) A device as claimed in any one of the foregoing claims, characterized in that the closing element (10) has a useful width (F) greater than the length (L) of said tongues, so that the end portions (7e) of said tongues face said application surface (13) when said closing element (10) is undeformed.

13) A device as claimed in any one of the foregoing claims, characterized in that each tongue (7) is rectangular with a rounded minor-side free end (7e).

14) A device as claimed in any one of the foregoing claims, characterized in that said closing element is strip-shaped.

15) A device as claimed in any one of the foregoing claims, characterized in that said closing element is made of cloth.

16) A bound bundle comprising a binding device and a number of sheets arranged in a pack; characterized in that said binding device comprises:
a flat sheet element (3) having, along one side (3a), a number of flexible tongues (7) arranged combfashion;
a closing element (10) extending along said side (3a) of the flat sheet element (3); said closing element (10) having an application surface (13) facing said tongues (7);
said flat sheet element (3) being placed on a first face (30a) of said pack, with said tongues (7) inserted inside respective holes (33) formed along an edge (30e) of the pack, and with respective ends (7e) of the tongues (7) projecting from the holes;
said closing element (10) being folded and placed with at least one portion (17) of the application surface (13) superimposed on and firmly connected to a flat element (30b) defining a second face of the pack (30) to form said bound bundle.
